(19) United States
(12) Patent Application Publication
(10) Pub. No.: US 2017/0283753 A1
(43) Pub. Date: Oct. 5, 2017

(54) Unknown

(71) Applicant: SEGUIN MOREAU & C°, Merpins (FR)

(72) Inventors: Benoit VERDIER, Gondeville (FR); Andrei PRIDA, Cognac (FR)

(21) Appl. No.: 15/478,546

(22) Filed: Apr. 4, 2017

(30) Foreign Application Priority Data
Apr. 4, 2016 (FR) 16/52917

(51) Int. Cl. C12H 1/22; B27K 5/00; B27H 5/00

(52) U.S. Cl. CPC C12H 1/22; B27H 5/00; B27K 5/001

(57) ABSTRACT

A wooden container provided for the maturation of a wine or a spirit, comprising wood pieces (6) elongated in the direction of the wood fibers, assembled together in the width in order to constitute a closed container, characterized in that it includes at least one wood piece (6) which has an inner surface in which at least one groove (36) is arranged forming an angle relative to the wood fibers representing the longitudinal axis of growth of the shaft, in order to obtain a cut of these fibers intended to be exposed to the liquid.

### TECHNICAL FIELD

The present invention concerns a wooden container provided to receive wines and spirits in order to ensure the maturation of these liquids, as well as methods for manufacturing such wooden containers.

### BACKGROUND

The maturation of wines and spirits in wooden containers, generally in oak, but also in other wood species as, in particular, chestnut or acacia is an important step in the elaboration of these liquids. During keg ageing, the wood extractable compounds diffuse into the wine by modifying the aroma and the taste thereof. In particular notes bringing a vanilla, coconut, spicy, smoky, grilled, coffee or caramel taste can be added.

Furthermore, a slow penetration of oxygen through the wood constituting the keg carries out a controlled oxidation of the substances present in the wine or the spirits, favorably modifying its organoleptic features such as the color, the taste or the smell thereof.

The closed wooden containers traditionally used in oenology for the maturation of wines and spirits may have different volumes and shapes, they are called in particular, keg, barrel, piece, drum or tun.

The wooden containers, hereinafter called in a generic manner keg, are composed of two main parts, the coat or shell forming a closed contour about a main axis, and the two bottoms coming at the ends of this shell. They are manufactured by coopers with the following usual method.

The shell, which may be circular or oval, is formed by a series of adjoining wood pieces called staves, disposed parallel to the main axis, including a bending giving the keg a more significant diameter in its central part in order to obtain the drum shape. The set of staves is held clamped by strapping of metal strips or cables which surround it at different heights.

Each bottom represents a circular or oval plane part, which is composed of a series of parallel wood pieces, called bottom pieces, held together by journals or by joining.

The wood pieces of the shell and of the bottom are obtained from casks directly cut out from the logs, then discharged according to a specific method depending on the wood species and on the thickness of the piece to be made, and finally dried in the open air before getting into the keg manufacturing method.

The casks for the staves are then subjected to different operations to be shortened, joined, in order to carry out the smoothing which flattens and thins them, and sometimes to hollow them out. After these operations these wood pieces now called staves, are fitted to form the shell of the keg.

The staves are assembled around a first circle by tightening an end of these pieces together, the other side of these staves remaining free blooming by forming a rose. A bending of the staves is then carried out to form the circle on the other side and give the final shape of the keg, which is performed mainly with firewood. Other steam or immersion bending techniques in hot water may also be used.

During the bending of the staves, the temperatures are not high enough to cause profound changes in wood. These wood changes occur on the contrary during a second heating, also called toasting. According to the intensity of this light, medium or strong second heating, wood is obtained with specific features. The coopers offer different heating programs in response to the expectations of winemakers and spirits' producers.

The bottoms of the containers are produced from wood pieces of the same quality as the casks, having a reduced length, also called bottom piece. These bottom pieces which are machined in a different manner relative to the casks as they do not undergo a bending, are planed on the four faces. The bottom pieces are then assembled with journals or by joining, and then the contour of the assembly is cut to obtain the final shape of the bottom.

The bottoms then undergo in some cases a heat treatment, including a superficial heating by radiation of electrical resistances, which reinforces the woody impact of the keg on the wine or the spirits. Then the two bottoms are assembled on the shell in order to obtain the closed volume. Finally, finishing operations such as sanding, marking and packaging are carried out, before the product is delivered.

This method of production raises in particular an issue of low penetration of the liquid inside the wood. Indeed, the first quality of a wooden container being its sealing, the least permeable wood face is exposed to the liquid. For example, for french oak casks, the surfaces of exposure to the liquid are disposed parallel to the direction of the wood fibers, which is the longitudinal direction of the trunk of the shaft, as well as the direction of the growth of the standing shaft.

The wine or spirits penetrate very little into the depth of these surfaces perpendicularly to the direction of the fibers, and thus extracts few compounds of this wood. It takes then a long time to obtain a sufficient extraction of the wood components from the beverage, which results in costs.

### BRIEF SUMMARY

The present invention aims in particular to avoid these drawbacks of the prior art.

For this purpose, it proposes a wooden container provided for the maturation of a wine or a spirit, comprising wood pieces elongated in the direction of the wood fibers, assembled together in order to constitute a closed container, this container being remarkable in that it includes at least one wood piece which has an inner surface in which at least one groove is arranged forming an angle relative to the wood fibers representing the longitudinal axis of growth of the shaft, in order to obtain a cut of these fibers intended to be exposed to the liquid.

An advantage of this wooden container lies in the fact that, the inner grooves of the wood pieces making a cut of the fibers, by definition in a direction generally transverse to these fibers, an easier penetration of the liquid inside the wood, and a faster extraction of the compounds of this wood are obtained by these cut ends.

A maturation of the wine or the spirits is then obtained within a period which is shortened.

The wooden container according to the invention may further include one or more of the following features, which may be combined together.

Advantageously, the grooves are disposed perpendicularly to the direction of the wood fibers. A larger exchange surface is obtained with the end of the wood fibers.

Advantageously, the depth of the grooves is less than or equal to half the thickness of the wood pieces. In this case, a sealing and a sufficient resistance of the wood pieces are maintained.

In particular, the depth of the grooves may be about five millimeters.

Advantageously, the spacing between two grooves is greater than ten millimeters. This minimum distance allows maintaining a solidity of the part between two grooves.

Advantageously, the cross section of the grooves forms a rectangle. This shape is easy to machine.

In particular, the container may form a shell along a closed contour, comprising, on its inner surface, closed continuous grooves along this contour.

Also disclosed herein is a method for manufacturing a wooden container having any one of the preceding features, including a step for machining grooves on individual wood pieces provided to form this container.

In a variant, the manufacturing method may include a step for machining grooves on bottoms including bottom pieces assembled together.

The invention also concerns a renovation method for obtaining a wooden container comprising any one of the preceding features, including a step for exchanging bottoms or staves with pieces having on the inner surface grooves intended to be exposed to the liquid.

The invention also concerns a method for manufacturing a wooden container having any one of the preceding features, the wood pieces being heat-treated beforehand prior to the assembling of the container.

### BRIEF DESCRIPTION OF THE DRAWINGS

The invention will be better understood and other features and advantages will appear more clearly on reading the description given below by way of example, with reference to the appended drawings in which:

FIG. 1 is a side view of a keg having a partial axial section;

FIG. 2 is a side view of a bottom of this keg;

FIG. 3 is a detailed view of the assembly of the bottom on the shell;

FIG. 4 shows grooves made on a wood piece cutting the fibers of this wood; and

FIGS. 5, 6 and 7 show for a keg according to the invention, respectively an axial section view, a side view and a view of the inner face of a stave, and a view of the inner face of a bottom.

### DETAILED DESCRIPTION

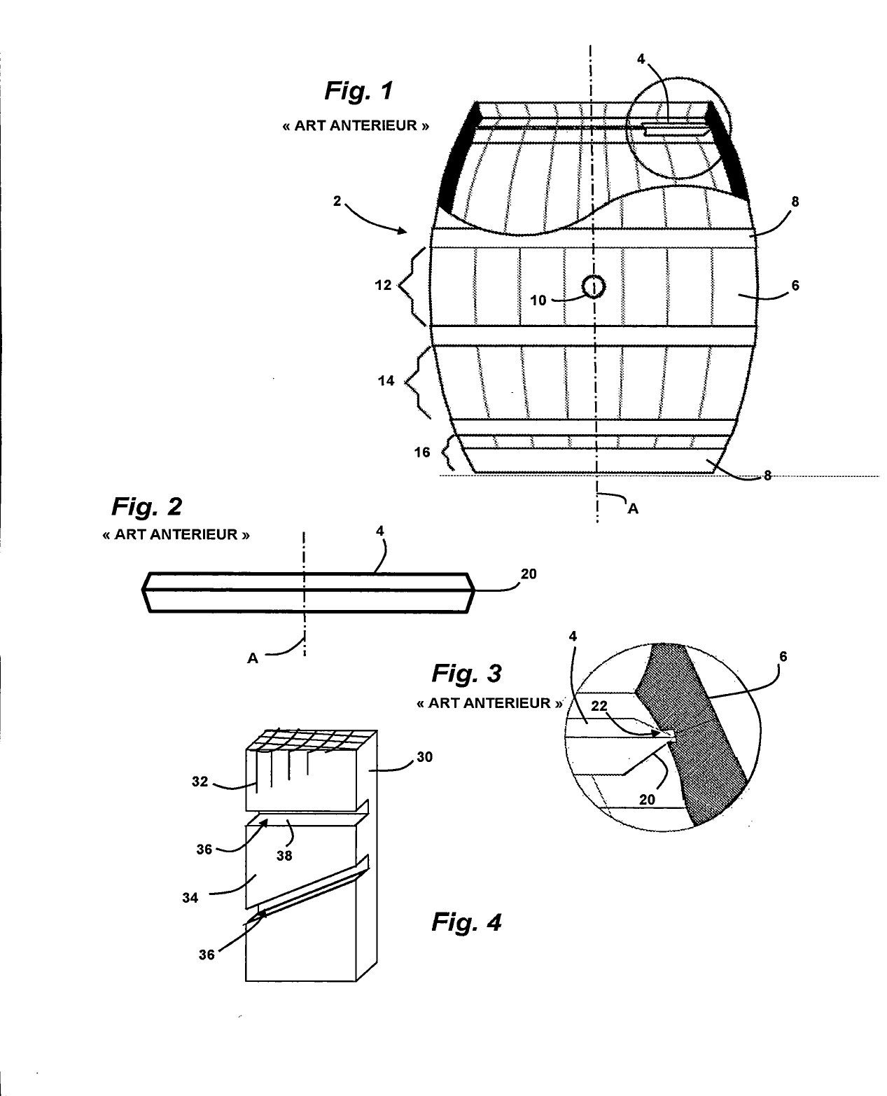

FIGS. 1, 2 and 3 show a keg including a circular shell 2 centered on a main axis A, receiving a bottom 4 at each end.

The shell 2 is formed by a series of staves 6 elongated in the direction of the wood fibers, which are clamped together widthwise, and held by a strapping 8 disposed at different heights.

The outer drum shape includes axially parts delimited by a strapping 8, comprising a central part 12 called a bulge having a piercing 10 for the exchange of the liquid, then on each side, a lateral part 14 called a collar, and finally a small end part 16 called a head which extends up to an end strapping.

Each bottom 4 formed by a series of bottom pieces clamped together has a circular contour forming, in an axial section, an outwardly directed tip 20. Near each end of the keg, the inner surface of the shell 2 includes a circular groove 22 perpendicular to the axis A, receiving the tip 20 of the contour of the bottom 4. The clamping of the outer strapping 8 ensures a continuous pressure on the contour of the bottoms 4, which makes the sealing.

FIG. 4 shows a wood piece 30 which may be a stave or a bottom piece, elongated in the longitudinal direction of the wood fibers 32, having on its inner face 34 exposed to the liquid, two grooves 36 of rectangular section machined in the wood on a part of the thickness of this part. The upper groove 36 cuts the wood fibers 32 perpendicularly to these fibers, the lower groove cuts them with an inclination of about 45°.

The lateral surfaces 38 of the grooves 36 constitute a privileged surface of liquid penetration into the wood fibers 32 by their cut ends.

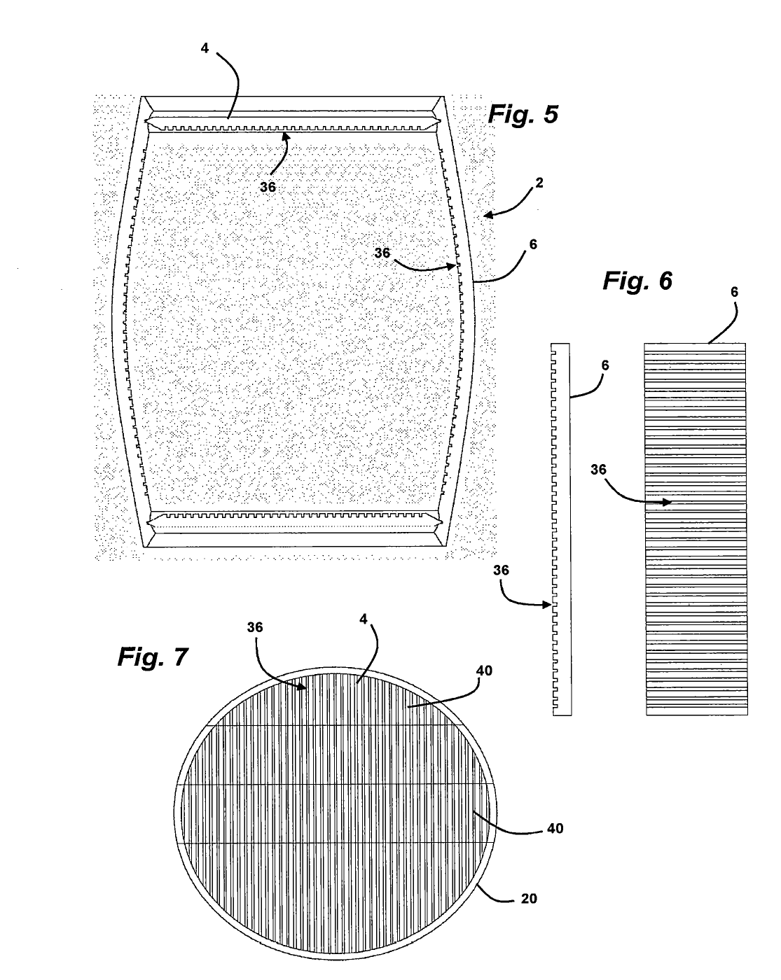

FIG. 5 shows a keg including, on the inner faces of the staves 6 and the bottoms 4, a series of parallel grooves 36 of rectangular section, having a depth equal to about 25% of the thickness of the wood pieces.

FIG. 6 shows about forty grooves 36 on the inner face of each stave 6, which are perpendicular to the longitudinal direction of this piece.

FIG. 7 shows about thirty-three grooves 36 on the inner face of the bottom 4, which are perpendicular to the longitudinal direction of each bottom piece 40.

A privileged surface of liquid penetration into the wood fibers, equal to the sum of the lateral surfaces of the grooves 36, is obtained for this keg, which may be calculated by multiplying twice the length of the grooves by their depth. In the case where the grooves 36 are not perpendicular to the direction of the wood fibers, this result should be multiplied by the sine of the angle formed between the direction of these fibers and the groove, in order to obtain a privileged equivalent exchange surface perpendicular to the fibers.

The liquid penetration rate into the wood is a limiting factor for the extraction of the oak extractable compounds. In the case of wine, studies show, according to the authors and the employed measurement methods, a penetration of this liquid into the wood comprised between two and four millimeters.

An index used for the measurement of the penetration of the liquid into the wood is the measurement of the moisture content of the fine zone at the surface of this wood according to the depth, which allows in these humidified zones an extraction of the compounds of this wood. It should be noted that the accessibility of the wood compounds is greatly reduced from the inner contact surface, while moving in the direction of the depth.

A study showed that the amount of whiskey-lactone forming a wood extractable compound which may be considered as a marker to estimate the percentage of extraction, enclosed in the surface layer of two millimeters thick after two years of ageing the beverage, and in the order of 50% relative to the new wood.

In practice, the grooves 36 are made by cutting tools in order to obtain a clear cut of the wood fibers, such as a saw or a milling machine. Advantageously, it has a width comprised between one and twenty-five millimeters.

The quantity of wood per liter of liquid we want to obtain, guided by the choice of oenologists or producers of spirits, is calculated by taking the total privileged exchange surface obtained with the grooves 36, multiplied by the wood density and divided by the volume of the container.

Advantageously, the maximum depth of the grooves 36 is limited to half the thickness of the wood pieces, in order to avoid risks of leakage through the container.

Advantageously, the distance between the grooves 36 is at least ten millimeters for obtaining a sufficient resistance of the wood remaining between two grooves and for avoiding its breakage. In this case, as shown in FIG. 5, with circular grooves perpendicular to the main axis made in the staves 6, and with parallel grooves made on the bottoms 4, the maximum possible privileged exchange surface is obtained.

Conversely, at least in order to obtain a low privileged exchange surface giving a slow extraction of the wood extractable compounds, a single groove may be made in the container.

A groove type 36 adapted for a standard use of a keg, giving a reasonable extraction rate of the wood components, has a depth of five millimeters and a spacing of one hundred millimeters.

In particular, the wood pieces undergoing the grooving may, before or after this machining operation of the grooves 36, be heat-treated prior to the assembling of the container, in particular by a heating with a convection oven, in order to reinforce the delivery of the heating compounds. This heat treatment may also be applied to all the pieces after their assembling. In particular, a type of treatment carried out in a convection oven for this type of wood pieces, applies a temperature of 180° C. for a period of three hours.

Different manners of making the grooves 36 are possible, including the machining of these grooves on the individual wood pieces before their assembling for the bottoms 4 and the shell 2, or on an assembled set provided in order to form a bottom 4.

In particular, the wood pieces may first be entirely formed, by planing the bottom pieces 40, or by shortening, joining and smoothing the raw casks, and then machining a series of grooves 36 transversely to the length on these individual parts thus formed. The machining of the grooves 36 is easily carried out on these individual pieces which are flat.

As a variant for the bottoms 4, the bottom pieces 40 may be first assembled together, and then the grooves 36 may be machined either before cutting out its outer contour, or after. This machining of the grooves 36 on the assembled bottoms 4 is easily carried out in the same manner on a surface which is flat.

The method according to the invention may be applied to new containers, such as in the renovation of used containers. The renovation of used containers includes exposing new wood surfaces which have not been impregnated by the previous use, and which have not bring their extractable compounds back.

Alternatively, for the renovation of used kegs, some wood pieces may be changed by introducing new grooved wood pieces, for example by changing some staves 6, or by changing only the complete bottoms 4, which represents an easier operation.

1. A wooden container provided for the maturation of a wine or a spirit, comprising
wood pieces elongated in a direction of the wood fibers, assembled together in order to constitute a closed container,
at least one heat-treated bottom piece which has an inner surface in which at least one groove is arranged forming an angle relative to the wood fibers representing a longitudinal axis of growth of a shaft, in order to obtain a cut of these fibers intended to be exposed to the liquid.

2. The wooden container according to claim 1, wherein the grooves are disposed perpendicularly to the direction of the wood fibers.

3. The wooden container according to claim 1, wherein a depth of the grooves is less than or equal to half a thickness of the wood pieces.

4. The wooden container according to claim 3, wherein the depth of the grooves is about five millimeters.

5. The wooden container according to claim 1, wherein the spacing between two grooves is greater than ten millimeters.

6. The wooden container according to claim 1, wherein the cross section of the grooves forms a rectangle.

7. The wooden container according to claim 1, further comprising a shell forming a closed contour, comprising on an inner surface closed continuous grooves along this contour.

8. A method for manufacturing a wooden container according to claim 1, further comprising a step for machining grooves on bottoms including bottom pieces assembled together.

9. A renovation method for obtaining a wooden container according to claim 1, comprising a step of exchanging bottoms or staves by pieces having on the inner surface grooves intended to be exposed to the liquid.

10. A method for manufacturing a wooden container according to claim 8, wherein the wood pieces are heat-treated beforehand prior to the assembling of the container.
